(19) United States
(12) Patent Application Publication
(10) Pub. No.: US 2001/0030692 A1
(43) Pub. Date: Oct. 18, 2001

(54) Imaging apparatus, image recording system, image recording apparatus and output characteristic correction method

(76) Inventor: Tadaaki Yoneda, Tokyo (JP)

Correspondence Address: CANTOR COLBURN LLP, 55 Griffin Road South, Bloomfield, CT, 06002, US

(21) Appl. No.: 09/829,820

(22) Filed: Apr. 10, 2001

(30) Foreign Application Priority Data
Apr. 13, 2000 (JP) 112454/2000

(51) Int. Cl. H04N 5/225; H04N 9/04

(52) U.S. Cl. 348/207; 348/222; 348/333.01; 348/372

(57) ABSTRACT

An imaging apparatus includes: an image sensor for inputting an object image and obtaining as an image signal; an image processor for conducting the image processing according to printer characteristic information on the obtained image signal; and a display device for displaying an image according to the image signal after the processing by the image processor.

### BACKGROUND OF THE INVENTION

The present invention relates to an imaging apparatus, image recording system and image recording apparatus.

As the electronic technology advances, an electronic still camera such as a digital still camera by which a photographed image is converted into the digital data and stored, is developed, and is already put in the market. Because the user can display the image photographed by the digital still camera, for example, on a display of his own personal computer, and can print through a printer, its application range has been getting very wide.

In this connection, when an object is photographed by using the electronic still camera, the photographer determines the framing of the object by the viewfinder or a pre-view moving image display, which is equipped on the camera, and waits the appropriate shutter timing, and by pressing a release button at an appropriate shutter timing, the object image is captured by the electronic still camera and converted into an image signal, and after the signal processing, JPEG image compression is conducted, and the image data is recorded in the recording medium such as a memory card, or the like.

Herein, in the pre-view moving image display, normally, in order to give the priority to the moving image property as view-finder function, the signal processing in which the actual signal processing is simplified, is conducted, or the image having the lower resolution than the display performance is displayed. Accordingly, the finally photographed image is not pre-viewed, and further, in the case where the printing is presupposed, the final printed condition of the image is not also pre-viewed.

Further, the electronic still camera also has a function to display the image after the photographing, and by such the function, the JPEG image compression data recorded in the recording medium described above is expanded and can be displayed on the image display section. However, also in this post-view, the image can be only looked as the image photographed by the electronic still camera, and is not looked as pre-viewing of the finished image by the printer.

Further, recently, in a dye-sublimation type thermal transfer system printer, or inkjet system printer, a printer having an exclusive use interface function for the electronic still camera is also put into the market. By using such the function, without the personal computer in which the software driver for the printer is installed, the image data can be directly transferred from the electronic still camera to the printer, and the image can be printed. As such the exclusive use interface for the electronic still camera, there is an interface in which a PC card socket is prepared and the recording medium of the electronic still camera is inserted into it through an adapter, or an interface which has an infrared communication function and by which the image is directly communicated with the electronic still camera without wire connection. Further, in the near future, it is considered that, when a USB host function is incorporated on the camera side, the camera can directly output the image data to the general purpose printer.

When the co-operation of the printer with the electronic still camera as described above, is considered, for example, like as a unit in which the electronic still camera and the printer are integrated with each other, when the printer is exclusively used for the electronic still camera, the print corresponding to the image data outputted from the electronic still camera can be carried out.

However, such the printer only has the function as an image viewer which outputs the image data outputted from the electronic still camera as it is. That is, the printer having a further multi-function can store the image to be composed, on the printer side, and conduct the synthesized printing, or can conduct the image processing such as cropping of a panorama area, however, even when the function according to the electronic still camera integrated printer is provided to the printer, when it can not be judged how is the finally printed image of the image, because the desired output is not obtained, re-print may be necessary, or the patience may be necessary for the undesired image, which is inconvenient and uneconomical.

Further, when, for example, the printer side is a general purpose apparatus, generally, the image characteristic such as the density gradation, color gamut or sharpness, is set to a standard characteristic, and in this case, until the image from the electronic still camera is actually printed, the finished print of the image can not be confirmed, which is inconvenient. Recently, a printer having a direct printing function by which, by using the infrared wireless communication function, the image to be printed is selected on the camera side, and directly sent to the printer side, is also put in the market, however, also in this case, the image displayed on the display function on the electronic still camera side, only provides a means for confirmation of the image to be sent to the printer at that time.

That is, it can be said that the conventional display function on the electronic still camera side in the cooperation of the electronic still camera and printer is limited for the photographed image confirmation, or is limited for the confirmation of the image to be printed.

Further, in the latest date, as disclosed in Japanese Tokkai-2000-318275 which applied by the present inventor, a printer equipped with a viewer function is also investigated, and the display in which the final print image is supposed, or also the result of the procedure for the print processing, is becoming possible on the installed viewer. In this apparatus, there is a great advantage in a point that it has the highly finer image display function than the display function provided on the electronic still camera side, however, on the other hand, it is also uneconomical that, although the viewer function is existing on the electronic still camera side, the viewer function is further provided on the printer side.

Further, it is a problem that, when the electronic still camera and printer use commonly a battery power source, what processing is conducted for the voltage drop of the battery.

### SUMMARY OF THE INVENTION

In view of the foregoing problems of the conventional technology, the object of the present invention is to provide an imaging apparatus, image recording system and image recording apparatus, by which a desired image print can be obtained without using personal computers.

The above object can be attained by either one of the following structures (1) through (15).

Structure (1):

An imaging apparatus comprises: an image sensor for inputting an object image and obtaining as an image signal; an image processing means for conducting the image processing according to the printer characteristic information on the obtained image signal; and a display means for displaying an image according to the image signal after the processing with the image processing means.

Structure (2):

An imaging apparatus comprises: an image sensor for inputting an object image and obtaining as an image signal; the first image processing means for conducting the image processing on the obtained image signal; the second image processing means for conducting the image processing according to the printer characteristic information on the obtained image signal; a selection means for selecting the first or the second image processing means; and a display means for displaying the image according to the image signal after the processing with the first or the second image processing means.

Structure (3):

An imaging apparatus comprises: an image sensor for inputting an object image and obtaining as an image signal; a storage means for storing the obtained image signal; the first image processing means for conducting the image processing on the stored image signal; the second image processing means for conducting the image processing according to the printer characteristic information on the stored image signal; a selection means for selecting the first or the second image processing means; and a display means for displaying the image according to the image signal after the processing with the first or the second image processing means.

Structure (4):

An image recording system comprises: an imaging apparatus having an image sensor for inputting an object image and obtaining as an image signal, and an output means for outputting the image signal to the outside; and an image recording apparatus having: an input means for inputting the outputted image signal; an image processing means for conducting the image processing according to the recording characteristic on the inputted image signal; an image recording means for conducting the print according to the image signal after the processing; and an output means for outputting the image signal to the outside after the processing.

Structure (5):

The image recording system comprises, an image recording apparatus having: an input means for inputting an image signal; an image processing means for conducting the image processing according to the printer characteristic on the inputted image signal; an image recording means for conducting the print according to the image signal after the processing; and an output means for outputting the image signal to the outside after the processing, and an image display apparatus having: the input means for inputting the image signal after the processing; and the image display means for displaying the image according to the inputted image signal.

Structure (6):

An image recording apparatus comprises: a means for inputting the image signal; an image processing means for conducting the image processing according to the print characteristic on the inputted image signal; an image recording means for conducting the print according to the image signal after the processing; and an output means for outputting the image signal to the outside after the processing.

Structure (7):

An imaging apparatus comprises: an image sensor for inputting the object image and obtaining the image signal; an image recording means for conducting the print according to the obtained image signal; a power source for supplying the power to the image sensor and the image recording means; and a control means for inhibiting the photographing operation by the image sensor during the recording by the image recording means.

Structure (8):

An imaging apparatus comprises: an image sensor for inputting the object image and obtaining the image signal; an image recording means for conducting the print according to the obtained image signal; a power source for supplying the power to the image sensor and the image recording means; and a means for judging whether the photographing operation by the image sensor is conducted, during the recording by the recording means, according to the information of the power consumption at the image recording means and the image sensor.

Structure (9):

An imaging apparatus comprises: an image sensor for inputting the object image and obtaining the image signal; an image recording means for conducting the print according to the obtained image signal; a power source for supplying the power to the image sensor and the image recording means; and a control means for temporarily stopping the recording operation and for conducting the photographing operation, when the photographing operation by the image sensor is indicated during the recording by the image recording means, and for restarting the recording operation after the completion of the photographing operation.

Structure (10):

An imaging apparatus comprises: an image sensor for inputting the object image and obtaining the image signal; a power source for supplying the power to the image sensor; an image recording means for receiving the power supply from the different power source from the above power source, and for conducting the printing according to the obtained image signal; and a control means for enabling the photographing operation to be conducted by the image sensor even during the recording operation by the image recording means.

Structure (11):

An imaging apparatus comprises: an image sensor for inputting the object image and obtaining the image signal; a transfer means for transferring a signal to the outside according to the obtained image signal; a power source for supplying the power to the image sensor and the transfer means; and a control means for inhibiting the photographing operation by the image sensor during the transfer by the transfer means.

Structure (12):

An imaging apparatus comprises: an image sensor for inputting the object image and obtaining the image signal; a transfer means for transferring a signal to the outside according to the obtained image signal; a power source for supplying the power to the image sensor and the transfer means, and a means for judging whether the photographing operation by the image sensor is conducted during the transfer by the transfer means, according to the information of power consumption of the transfer means and the image sensor.

Structure (13):

An imaging apparatus comprises: an image sensor for inputting the object image and obtaining the image signal; a transfer means for transferring a signal to the outside according to the obtained image signal; a display means for displaying the image according to the image signal; a power source for supplying the power to the image sensor and the transfer means; and a control means for decreasing the brightness of the image display by the display means during the transfer by the transfer means.

Structure (14):

An output characteristic correction method comprises: a step for photographing a predetermined image and obtaining an image signal; a step for outputting an image according to a predetermined output characteristic and the image signal obtained by the image sensor; and a step for correcting the predetermined output characteristic according to the outputted image and the predetermined image.

Structure (15):

An output characteristic correction method comprises: a step for photographing a predetermined image and obtaining the first image signal; a step for outputting an image according to a predetermined output characteristic and the first image signal obtained by the image sensor; a step for photographing the image and obtaining the second image signal; and a step for correcting the predetermined output characteristic according to the first image signal and the second image signal.

Because the imaging apparatus of the Structure (1) described above has an image sensor for inputting an object image and obtaining as an image signal, an image processing means for conducting the image processing according to the printer characteristic information on the obtained image signal, and a display means for displaying the image according to the image signal after the processing by the image processing means, for example, when the print is conducted from a general purpose printer according to the image signal obtained by the image sensor, the optimum image processing when the print is conducted by such the printer, can be conducted on the image signal according to the printer characteristic information prior to the print, accordingly, the image signal can be directly transferred not through the personal computer, and the print having the high image quality can be easily obtained. Further, before the image signal is outputted to the printer, because the image can be confirmed by the display means, for example, the finished image condition of the composite image can be confirmed in advance, which is convenient. Herein, “the printer characteristic information” is the information relating to the density characteristic of the printer or the sharpness characteristic, or in the case of the printer using an ink ribbon, includes the information relating to a size of the ribbon or color, but, is not limited to that. In this connection, as an example of the imaging apparatus, the electronic camera is listed, but, the imaging apparatus is not limited to it.

Because the imaging apparatus of the Structure (2) has the image sensor for inputting the object image and obtaining as the image signal, the first image processing means for conducting the image processing on the obtained image signal, the second image processing means for conducting the image processing according to the printer characteristic information, the selection means for selecting the first or the second image processing means, and the display means for displaying the image according to the image signal after the processing by the first or second image processing means, for example, when the print is conducted from a general purpose printer according to the image signal obtained by the image sensor, the selection means can select that the optimum image processing is conducted on the image signal prior to the print when the print is conducted by such the printer, and in such the case, the image signal is directly transferred not through the personal computer, and the print having the high image quality can be easily obtained. Further, when the print is not conducted and the image signal is stored in a certain storage medium, the selection means can also select that the first image processing means conducts the general image processing. Further, because, according to the image signal processed by any one of image processing, the image can be confirmed by the display means, it is convenient.

Because the imaging apparatus of the Structure (3) has the image sensor for inputting the object image and obtaining as the image signal, a storage means for storing the obtained image signal, the first image processing means for conducting the image processing on the stored image signal, the second image processing means for conducting the image processing on the stored image signal according to the printer characteristic information, a selection means for selecting the first or the second image processing means, and a display means for displaying the image according to the image signal after the processing by the first or the second image processing means, for example, when the print is conducted from the general purpose printer according to the image signal obtained by the image sensor and stored in the storage means, because the selection means can select that the optimum image processing when the print is conducted by such the printer, is conducted on the image signal prior to the print, by the second image processing means, according to the printer characteristic information, in such the case, the image signal is directly transferred not through the personal computer, and the print having the high image quality can be easily obtained. Further, when the image print is not conducted, the selection means can also select that the first image processing means conducts the general image processing. Further, because, according to the image signal processed by any one of image processing, the image can be confirmed by the display means, it is convenient.

Further, when the imaging apparatus has the printer characteristic information, every time when the imaging apparatus is connected to the printer, it is not necessary that the printer characteristic information is read out, and the print can be quickly conducted.

Further, when an input means by which the printer characteristic information can be inputted from the outside, is provided, for example, even a printer which can not output the printer characteristic information when it is connected to the imaging apparatus, by reading out the printer characteristic information stored, for example, in the memory card by using the memory card input means, the adequate print can be conducted by such the printer. In this connection, as an input means, it is not limited to the reading apparatus of the memory card, but, other than the communication means which can be connected to the server in the printer manufacturer through the network, various modes can be considered.

Further, at the time of connection to the printer, when the printer characteristic information is inputted by the printer, it is not necessary that the printer characteristic information is inputted corresponding to the connected printer, which is convenient.

Further, when the selection means conducts the selection by the connection to the printer, for example, when the printer is not connected, because the image processing is not necessary by the second image processing means, the proper use can be selected in such a manner that the image processing by the first image processing means is selected, which is convenient.

Accordingly, at the time of connection to the printer, it is preferable that the second image processing means is selected.

The image recording system of the Structure (4) comprises: the imaging apparatus having the image sensor for inputting the object image and obtaining as the image signal, and the output means for outputting the image signal to the outside; and the image recording apparatus having the input means for inputting the outputted image signal, the image processing means for conducting the image processing on the inputted image signal according to the recording characteristic, the image recording means for conducting the print according to the image signal after the processing, and the output means for outputting the image signal to the outside after the processing. For example, there is sometimes a case where a CPU in the image recording apparatus (for example, the printer) has higher performance than that in the imaging apparatus (for example, the electronic camera). In such the case, when the image processing is conducted on the image recording apparatus side, the image processing can be more quickly and multi-functionally conducted rather than the case where the image processing is conducted on the imaging apparatus side. Accordingly, in the present embodiment, the structure in which the image signal obtained by the imaging apparatus is transferred to the image recording apparatus side, and the image processing is conducted by the image processing means, and the processed image signal is outputted by the output means, is applied. In this connection, the processed image signal may also be returned to the original imaging apparatus, or may also be outputted to other imaging apparatus or personal computer.

Further, when the imaging apparatus is connected to the image recording apparatus, it is preferable that the image recording apparatus conducts the processing operation according to the indication from the imaging apparatus.

Further, when the image signal after the processing is inputted into the imaging apparatus, and the image display according to the image signal is conducted, for example, when the display is provided in the imaging apparatus, because the image displayed through such the display, according to the image signal on which the processing which can not be conducted by the imaging apparatus is conducted, can be confirmed, it is preferable. In the style of the image signal output, it is considered that the output is conducted through the cable connection, and further, wireless connection such as IrDA, or recording medium such as the memory card.

Further, it is preferable when the template processing can be conducted on the inputted image signal in the image recording apparatus. “The template processing” means that the image processing is conducted on the photographed image so that it is formed into the form of a New Year's card or calendar, the image composition is conducted as if the object is settled in a photo-frame, or as if the object is photographed together with cartoon characters, or the processing to compose a beautiful landscape and the object image, but, it is not limited to those.

The image recording system of the Structure (5) comprises: the image recording apparatus having the input means for inputting the image signal, the image processing means for conducting the image processing on the inputted image signal according to the printer characteristic, the image recording means for conducting the print according to the image signal after the processing, and the output means for outputting the image signal after the processing to the outside; and the image display apparatus having the input means for inputting the image signal after the processing, and the image display means for displaying the image according to the inputted image signal. For example, the image signal obtained from the imaging apparatus such as the electronic still camera is required to be image processed corresponding to the output characteristic of the printer before the image is printed by the printer, however, in the case of the present invention, the image processing is not conducted on the imaging apparatus side, but the image processing is conducted on the image recording apparatus side, thereby, the structure of the imaging apparatus and printer side can be simplified. Further, because, according to the image processed image signal, the image can be confirmed by the image display means, for example, because the finished image condition of the composite image can be confirmed in advance, it is convenient.

Further, it is preferable that the image display apparatus has the image sensor for inputting the object image and for obtaining as the image signal. That is, the image display apparatus may be an electronic camera provided with a display on which the image can be displayed, but is not limited to this.

Further, when the image display apparatus and the image recording apparatus are connected to each other, it is preferable that the image recording apparatus conducts the recording operation according to the indication from the image display apparatus.

Further, it is preferable that, in the image recording apparatus, the template processing can be conducted on the inputted image signal.

Because the image recording apparatus of the Structure (6) comprises: the means for inputting the image signal; the image processing means for conducting the image processing on the inputted image signal according to the print characteristic; the image recording means for conducting the print according to the image signal after the processing; and the output means for outputting the image signal to the outside after the processing, the print of the image can be conducted, after the image processing is conducted on the image signal outputted from, for example, the electronic camera, according to its own print characteristic, thereby, the image with the high image quality is obtained.

Further, it is preferable that, in the image recording apparatus, the template processing can be conducted on the inputted image signal.

Because the imaging apparatus of the Structure (7) comprises: the image sensor for inputting the object image and for obtaining the image signal; the image recording means for conducting the print according to the obtained image signal; the power source for supplying the power to the image sensor and the image recording means; and the control means for inhibiting the photographing operation by the image sensor during the recording by the image recording means, both the print of the image with the higher image quality and the capturing of the clear image signal not including the noise can be obtained, because the interference due to simultaneously is suppressed when the recording and photographing according to the electric power from a single power source with the limited power capacity is used.

Because the imaging apparatus of the Structure (8) comprises: the image sensor for inputting the object image and for obtaining the image signal; the image recording means for conducting the print according to the obtained image signal; the power source for supplying the power to the image sensor and the image recording means; and a means for judging whether the photographing operation by the image sensor is conducted during the recording by the recording means, according to the information of power consumption in the image recording means and the image sensor, for example, when the battery whose capable electric power is limited, is used as the power source, because it can be judged by the information of power consumption such as the voltage whether the photographing operation can be conducted, when the photographing can not be conducted, the processing to inhibit the photographing can be taken, thereby, the inadequate photographing can be suppressed.

Because the imaging apparatus of the Structure (9) comprises: the image sensor for inputting the object image and for obtaining the image signal; the image recording means for conducting the print according to the obtained image signal; the power source for supplying the power to the image sensor and the image recording means; and the control means for temporarily stopping the recording operation when the photographing operation by the image sensor is ordered during the recording by the image recording means and for conducting the photographing operation, and for restarting the recording operation after the photographing operation is completed, both the print of the image with the higher image quality and the capturing of the clear image signal not including the noise can be obtained, because the interference due to simultaneously conducting the recording and photographing is suppressed.

Because the imaging apparatus of the Structure (10) comprises: the image sensor for inputting the object image and for obtaining the image signal; the power source for supplying the power to the image sensor; the image recording means for receiving the power supply from the different power source from the foregoing power source and for conducting the print according to the obtained image signal; and a control means for enabling to conduct the photographing operation by the image sensor even during the recording operation by the image recording means, both the print of the image with the higher image quality and the capturing of the clear image signal not including the noise can be obtained, because the interference due to simultaneously conducting the recording and photographing is suppressed when the electric power from a single power source with the limited power capacity is used.

Because the imaging apparatus of the Structure (11) comprises: the image sensor for inputting the object image and for obtaining the image signal; the transfer for transferring the signal to the outside according to the obtained image signal; the power source for supplying the power to the image sensor and the transfer; and the control means for inhibiting the photographing operation by the image sensor, both the print of the image with the higher image quality and the transferring of the clear image signal not including the noise can be obtained, because the interference due to simultaneously conducting the transferring and photographing is suppressed when the electric power from a single power source with the limited power capacity is used.

Because the imaging apparatus of the Structure (12) comprises: the image sensor for inputting the object image and for obtaining the image signal; the transfer for transferring the signal to the outside according to the obtained image signal; the power source for supplying the power to the image sensor and the transfer; and a means for judging whether the photographing operation by the image sensor is conducted during the transfer by the transfer, according to the information of power consumption in the transfer and the image sensor, for example, when the battery whose capable electric power is limited, is used as the power source, because it can be judged by the information of the power consumption such as the voltage whether the photographing operation can be conducted, when the photographing can not be conducted because the image signal is transferred, the processing to inhibit the photographing can be taken, thereby, the inadequate photographing can be suppressed.

Because the imaging apparatus of the structure (13) comprises: the image sensor for inputting the object image and for obtaining the image signal; the transfer for transferring the signal to the outside according to the obtained image signal; the display means for displaying the image according to the image signal; the power source for supplying the power to the image sensor and the transfer; and the control means for decreasing the brightness of the image display by the display means during the transfer by the transfer, for example, when the battery whose capable electric power is limited, is used as the power source, because it can be judged by the information of the power consumption such as the voltage whether the transferring operation can be conducted, when the transfer can not be conducted because the image signal is displaying, the processing to lower the brightness of the image display for intending the energy saving and to conduct the transfer can be taken, thereby, the transfer operation can continue as long as possible.

In this connection, in the case where the power of the battery is much consumed, when the control means inhibits the image display, because the more energy saving can be attained, thereby the possibility of the transferring can be increased.

Because the output characteristic correction method of the Structure (14) comprises: a step to photograph a predetermined image and to obtain the image signal; a step to output the image according to a predetermined output characteristic and the image signal obtained by the image sensor; and a step to correct the predetermined output characteristic according to the outputted image and the predetermined image, for example, in the case where the printer whose output characteristic is quite unknown is used, when, according to the image signal obtained by photographing the image such as the color patch, the color patch image is printed by such the color printer as it is, and the printed color patch is compared to the original color patch, thereby, the output characteristic is corrected so that the optimum image quality can be obtained, the image with the higher image quality can be obtained.

Because the output characteristic correction method of the Structure (15) comprises: the step to photograph a predetermined image and to obtain the first image signal; the step to output the image according to the predetermined output characteristic and the first image signal obtained by the image sensor; a step to photograph the image and to obtain the second image signal, and a step to correct the predetermined output characteristic according to the first image signal and the second image signal, for example, in the case where the printer whose output characteristic is quite unknown is used, when, according to the image signal obtained by photographing the image such as the color patch, the color patch image is printed by the color printer as it is, and the image signal obtained by photographing it is compared to the image signal obtained by photographing the original color patch, and thereby the output characteristic is corrected so that the optimum image quality can be obtained, the image with the higher image quality can be obtained.

### BRIEF DESCRIPTION OF THE DRAWINGS

FIG. 1 is a block diagram showing the structure of a printer integrated type electronic camera as an imaging apparatus or an image display apparatus according to the first embodiment.

FIG. 2 is a block diagram of a camera unit 10′ and a printer unit 50′ showing the second embodiment.

FIG. 3 is a ladder chart showing the transferring and receiving of a signal between the camera unit 10′ and the printer unit 50′ according to the second embodiment.

FIG. 4 is a ladder chart showing an example of the transferring and receiving of the instruction between the camera unit 10 and the printer unit 50 when these units are inside communication connected, according to the first embodiment.

FIG. 5 is a view showing the Laplacian transformation equation conducted on the image data for conducting the edge emphasis processing.

FIG. 6 is a view showing an example of a instruction system whose instruction is transferred and received between the electronic camera section 10 and the print section 50.

FIG. 7 is a black diagram showing the structure of the external interface section.

FIGS. 8(a), 8(b) and 8(c) are views showing examples of the image displayed on the electronic camera section 10 of the present embodiment.

FIG. 9(a) is a view showing an example of a frame packet instruction used for the binary image data transferring from the electronic camera section to the printer section in FIG. 9(b).

FIG. 9(b) is a view showing an example of a frame structure of the binary image data transferring from the electronic camera section to the printer section.

FIG. 10(a) is a view showing an example of a frame packet instruction used for the binary image data transferring from the printer section to the electronic camera section in FIG. 10(b).

FIG. 10(b) is a view showing an example of a frame structure of the binary image data transferring from the printer section to the electronic camera section.

FIG. 11 is a view showing an example of the image processing such as the image synthesis processing, according to the instruction transferred and received between the electronic camera section 10 and the print section 50.

FIG. 12 is a perspective view showing a condition in which the camera unit 10′ and the printer unit 50′ are connected to each other.

FIG. 13 is a view for explaining an output characteristic correction method according to the third embodiment.

FIG. 14 is a flow chart showing the control according to the present embodiment.

FIG. 15 is a flow chart showing the control according to the present embodiment.

FIGS. 16(a), 16(b), 16(c), and 16(d) are views showing examples of displays on a display screen 32.

FIG. 17 is a view showing an example of Get Device Power State.

FIG. 18 is a flow chart showing the control for arbitrating the timing between the printing and the photographing.

### DETAILED DESCRIPTION OF THE PREFERRED EMBODIMENT

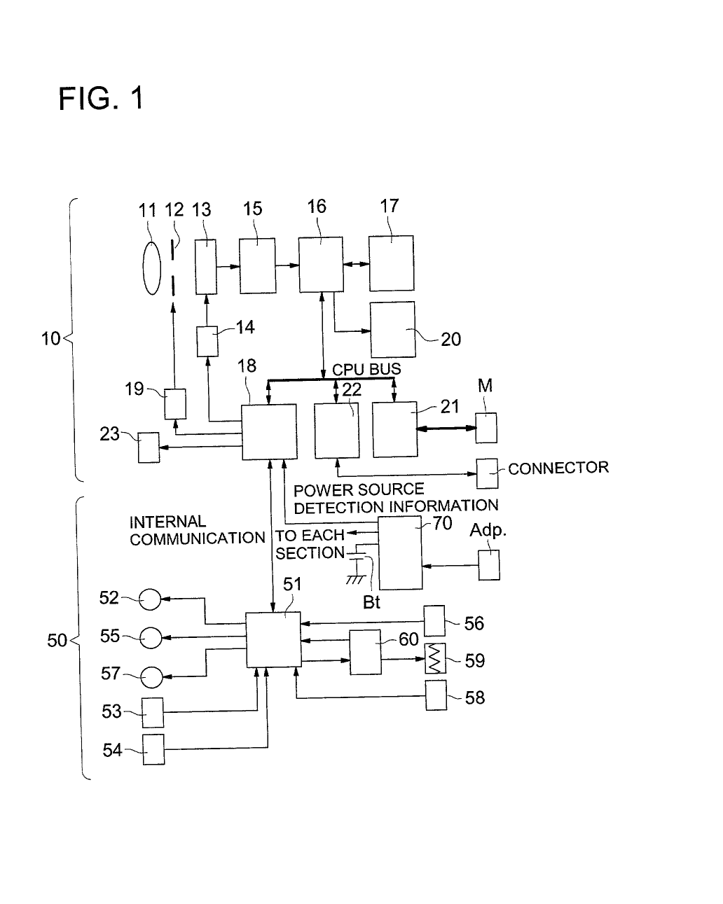

Referring to the drawings, an embodiment of the present invention will be described below. FIG. 1 is a block diagram showing the structure of a printer integrated electronic camera as an imaging apparatus or an image display apparatus according to the first embodiment. The printer integrated camera is structured by an electronic camera section 10 and a print section 50. In the electronic camera section 10, an object image is image formed on a light receiving surface of an image sensor (image pick-up element) 13 such as a CCD or CMOS through a lens 11 and a diaphragm/shutter 12. The image sensor 13 is driven by an image pick-up drive section 14, and converts the object image into an electric image signal (image signal)and outputs it. The image signal is AD converted, for example, after the correlation double sampling or the AGC processing is conducted by the front signal processing section 15, and outputted to an image taking-in section 16 as a digital image signal. In the image taking-in section 16, the inputted digital image signal is temporarily stored in an image storage section 17 using a SDRAM or other.

Simultaneously, in the image taking-in section 16, the statistical processing such as, for example, the average brightness processing can be conducted on the brightness information of the image, and by using the data, the calculation of a right exposure value is conducted by a camera control CPU 18, and by using the result, the diaphragm or shutter control is conducted by a diaphragm and shutter drive section 19. Further, in the actual photographing, which will be described later, the strobe light emission control of a strobe apparatus 23 is also conducted, and a right image exposure is given.

During a pre-view image display operation before the photographing, in the image taking-in section 16, the image signal is stored in the image storage section 17, and simultaneously the stored image signal is chromatically signal processed by the hardware signal processing, and is transferred to an image display section 20 as an image display means, and is displayed as an image on the display screen such as, for example, a color LCD.

Further, a release button signal, not shown, can be inputted into a camera control CPU 18, and the camera control CPU 18 into which the signal is inputted detects the photographic intention of the photographer, and switches to the photographing mode. In the photographing mode, the high resolution image signal is taken in by the image sensor 13, and stored in the image storage section 17, as described above.

Herein, in the camera control CPU 18, the chromatic processing and image compression processing are conducted on the obtained image signal by the software processing, and stored in a memory card M in an appropriate image file format. In this connection, it is connected to the peripheral equipments or the PC, and when the image signal is inputted to and outputted from these equipments, the external interface section 22 is used.

Next, a print section 50 will be described. In the print section 50 as the image recording apparatus, the image is printed according to a print condition (number of sheets, or similar conditions) received from the camera control CPU 18, or the image signal transferred from the camera control CPU 18. In this case, the processing to correct a color gamut of the electronic camera section side 10 and a color gamut of printing, or according to circumstances, the user's preferable sharpness emphasis processing or image tone processing is also conducted on the transferred image signal prior to print. In the print, in the printer control CPU section 51, the image receiving sheet of printing is conveyed by a sheet feeding motor 52, and the position of a print area is determined by using the first paper sensor 53 to confirm the leading edge position of the image receiving sheet and the second paper sensor 54 to detect the trailing edge position of the image receiving sheet. When the sheet reaches the print position, within an image recording means, a head motor 55, is driven by the printer control CPU section 51, and a head 59 which is heated while being temperature controlled by a head energy control section 60, is taken down, and a dyeing ribbon is brought into close contact with the image receiving sheet, and the print of the image is started according to the image signal transferred from the electronic camera section 10.

At this time, simultaneously the head temperature is acquired by the head temperature thermister 56, and the density of the print image is corrected according to the density correction value by the head temperature. In the printing, the image of the dyeing ribbon is transferred onto the image receiving sheet by the heat given from the head 59, while the dyeing ribbon and the image receiving sheet are being fed by the sheet feed motor 52, and the dyeing ribbon which is completed on dye transferring, is wound up by a ribbon motor 57. Further, when the print of one color component is completed, the head 59 is lifted up by a head motor 55, and the image receiving sheet is returned to the print start position by the sheet feed motor 52, the first paper sensor 53 and the second paper sensor 54, and the heading position of the next color of the dyeing ribbon is arranged by the ribbon motor 57 and a ribbon sensor 58.

Herein, the print section 50 using a thermal transfer type print method is shown, however, it is clear that the present invention does not depend on the print method, and for example, the present invention may also be applied for an inkjet method or silver halide exposure method.

In this case, because the electronic camera section 10 and the print section 50, constituting the image recording system, are integrated, the camera control CPU 18 can set the printer characteristic (printing characteristic) of the print section 50 or the characteristic of the image display section 20 in, for example, EEPROM prior to printing. When the different processing by using the known characteristic is conducted on the image signal stored in the image storage section 17, the finished print image can be displayed on the image display section 20, rather than the conventional photographing pre-view image. In this connection, the camera control CPU 18 that is also the selection means does not select such the image processing, but can select to conduct only normal image processing.

Herein, the CCD signal processing, image decompression processing, and the memory card recording on the electronic camera section 10 side correspond to the first image processing, and the sharpness emphasis processing, image tone processing, color gamut conversion processing, and the thermal density correction processing correspond to the second image processing. Further, according to the calculation result, result image of the print processing is converted into the image for display, and the image display section 20 which displays the image, on the electronic camera section 10 side is a display means for displaying the image according to the image signal after the first or second image processing. In this connection, as an example of the sharpness processing in the print section 50, when the image data is Laplacian transformed by using the function as shown in FIG. 5, the edge emphasis of the image can be conducted.

In this connection, relating to the internal communication connection of the electronic camera section 10 and the print section 50, for example, by using the communication means such as the clock synchronized serial communication inside the apparatus, the transferring and receiving of the instruction or data can be conducted.

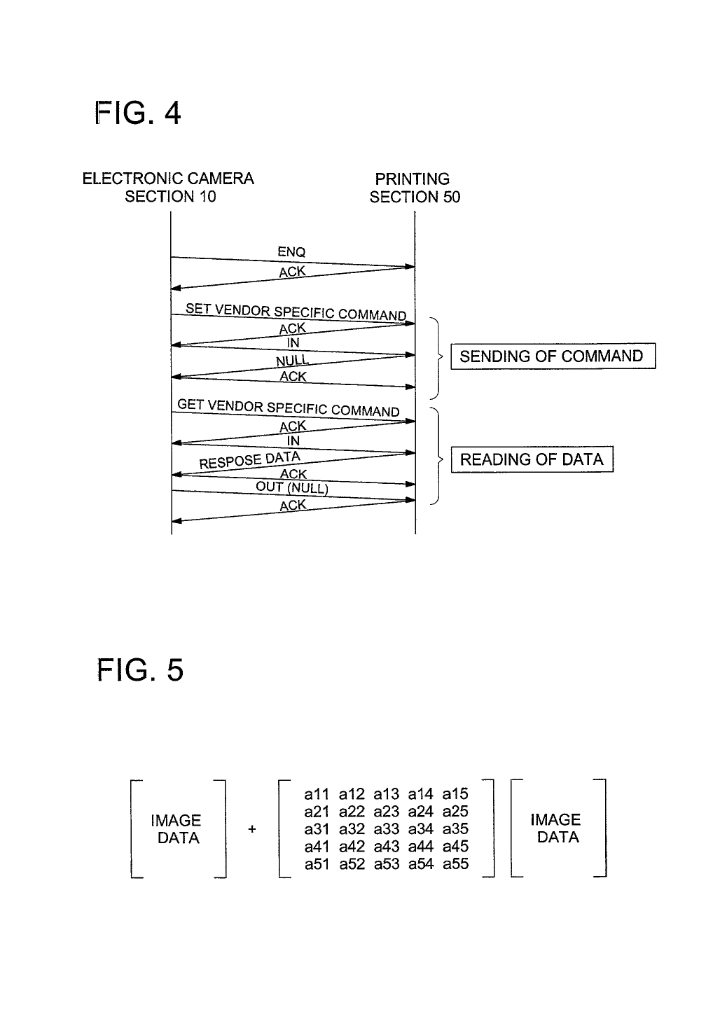

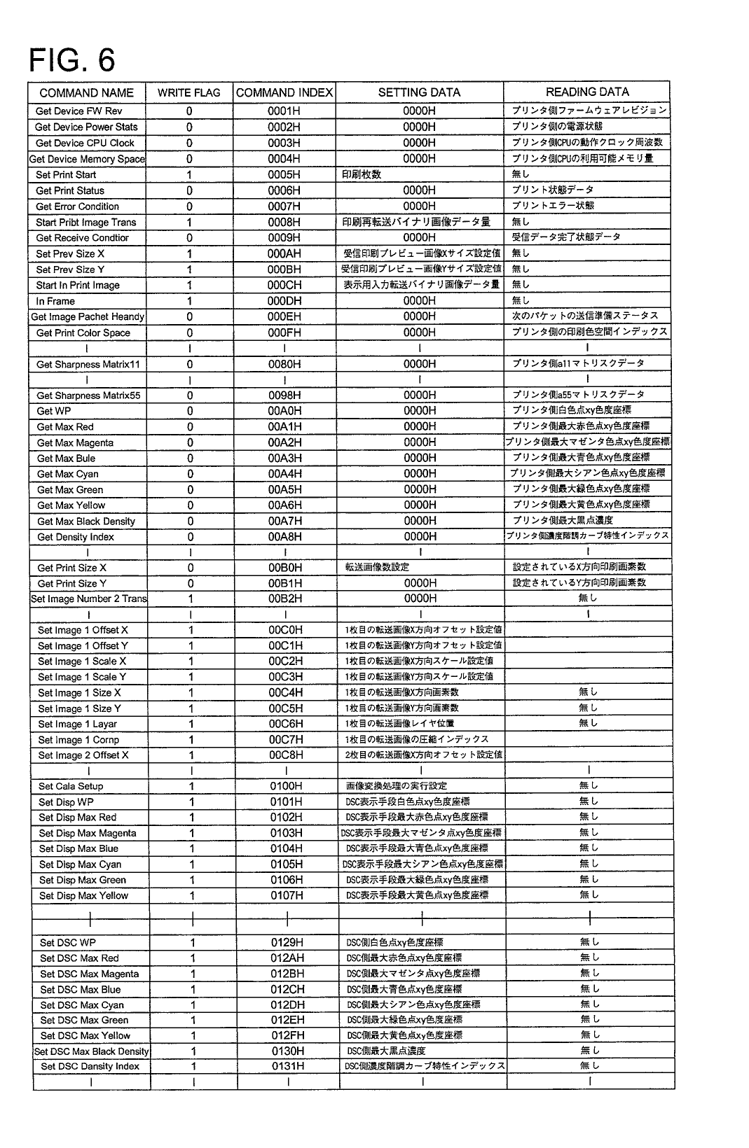

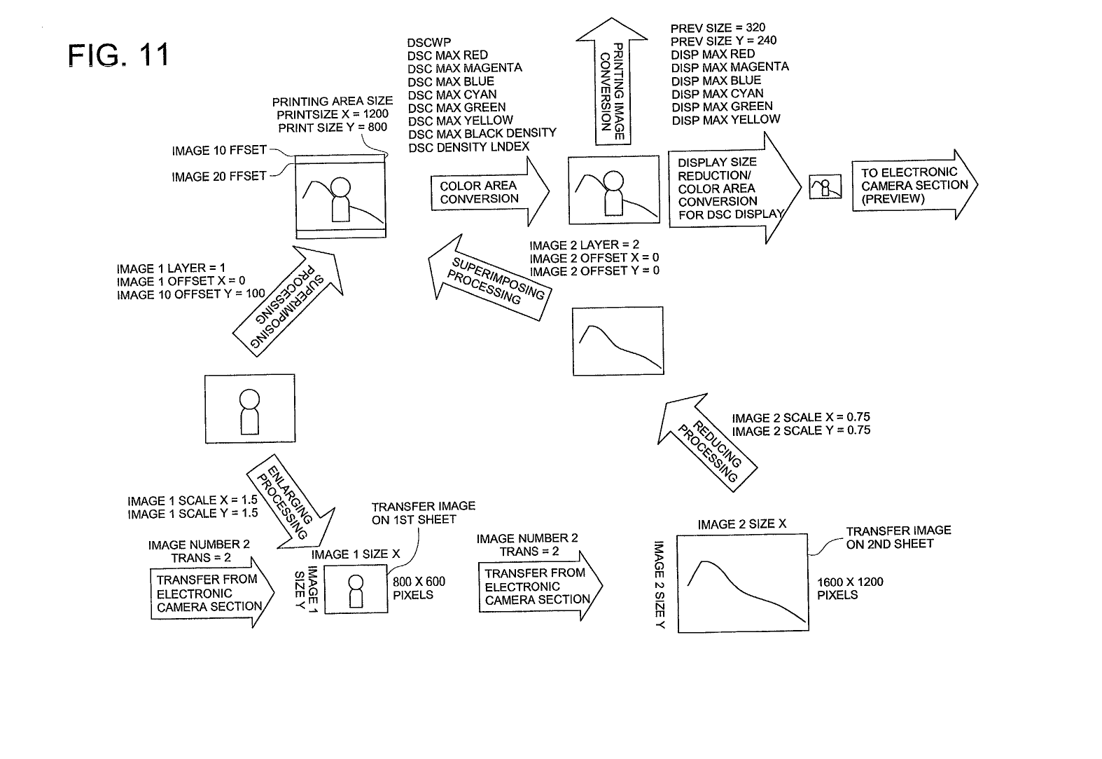

A ladder chart showing an example of the transferring and receiving of the instruction between the electronic camera section 10 and the print section 50 when these are internally communication connected, is shown in FIG. 4. In this case, the camera control CPU 18 is a master side, and the printer control CPU 51 is a slave side. Initially, from the camera control CPU 18 which is the master side, the code ENQ which means that the communication is started from this time, is synchronized with the communication clock, and is outputted to the printer control CPU 51 which is the slave side. On opposite side, corresponding to the synchronous clock outputted from the camera control CPU 18, the printer control CPU 51 returns the code ACK when the communication is available. Thereby, the camera control CPU 18 recognizes that the communication can be established to the print section 50, and conducts the command indication and the data reading-out hereafter, and transfers and receives the exclusive-use instruction between the electronic camera section 10 and the printer section 50. FIG. 6 is a view showing an example of the instruction system. The instruction shown in FIG. 6 is an example, and the instruction is not limited to this. FIG. 11 is a view showing an example of the image processing such as the image synthesis processing according to such the instruction, and in this example, the image processing is conducted in the printer control CPU 51, and the image data after the processing is transferred to the electronic camera section 10 side, and it can be made to conduct the pre-print confirmation display.

FIGS. 8(a), 8(b), and 8(c) are views showing images displayed on the electronic camera section 10 of the present embodiment. FIG. 8(a) is a view showing a photographic preview image, and displayed on the display screen of the image display section 20. After the photographer confirms such the condition, when the photographer operates the release button, the photographing is conducted, and the image data is stored in the image storage section 17. FIG. 8(b) is a view showing the image confirmed after the image shooting that is displayed based on the image data. Further, corresponding to the printer characteristic of the print section 50, the image processing of the image data is conducted. FIG. 8(c) is a view showing the confirmation image before the print displayed according to the image data after the processing. The operator confirms the color and a size of the image shown in FIG. 8(c), and by operating the print execution button, not shown, the print is conducted.

According to the present embodiment, when the print is conducted from the print section 50 according to the image signal obtained from the image sensor 13 of the electronic camera section 10, or according to the image signal stored in the image storage section 17 as the storage means, the optimum image processing when the print is conducted in such the print section 50 according to the printer characteristic information stored in the EEPROM, can be conducted on the image signal prior to the print, and accordingly, the image signal can be directly transferred not through the personal computer, and the print with the high image quality can be easily obtained. Further, before the image signal is outputted to the print section 50, because the image can be confirmed on the image display section 20, thereby, the finished image condition such as, for example, the composed image can be confirmed prior to the print, which is convenient.

In this connection, when the image signal is stored in the memory card which is a storage medium without the image printing, it can also be selected that the general image processing is conducted as the first image processing, without the second image processing. Further, according also to the image signal on which any image processing of both is conducted, because the image can be confirmed on the image display section 20, it is convenient.

Further, because the camera control CPU 18 recognizes the printer characteristic information, it is not necessary that the printer characteristic information is read from the print section 50 for each time of the printing, thereby, the print can be quickly conducted.

Further, when the external interface section 22 as the input means or memory card control section 21 can input the printer characteristic information from the outside, even when the printer characteristic is unknown, for example, the manufacturer information of the printer is used, and through the network or by reading out the printer characteristic information stored in the memory card M, when the appropriate image processing is conducted, the appropriate print can be conducted by the print section 50.

Further, at the time of communication to the print section 50, the printer characteristic may be inputted from the print section 50.

Further, because the camera control CPU 18 (or it may be the printer control CPU 51) operates depending on the establishment of communication or non-establishment with the print section 50, this system can be properly used in such a manner that, for example, when the print section 50 is not connected to the electronic camera section 10, because the second image processing is not necessary, the first image processing is selected, which is convenient.

By the way, in FIG. 1, the electronic camera section 10 and the print section 50 are operated according to the electric power from the power source section 70 which switches the electric power from the AC adapter Adp or from the battery Bt.

However, the electric power supplied from the AC adapter is stable while the electric power supplied from the battery is unstable because it varies depending on its remained power. Accordingly, in the present embodiment, when the electric power is supplied from the battery Bt, the following control is conducted.

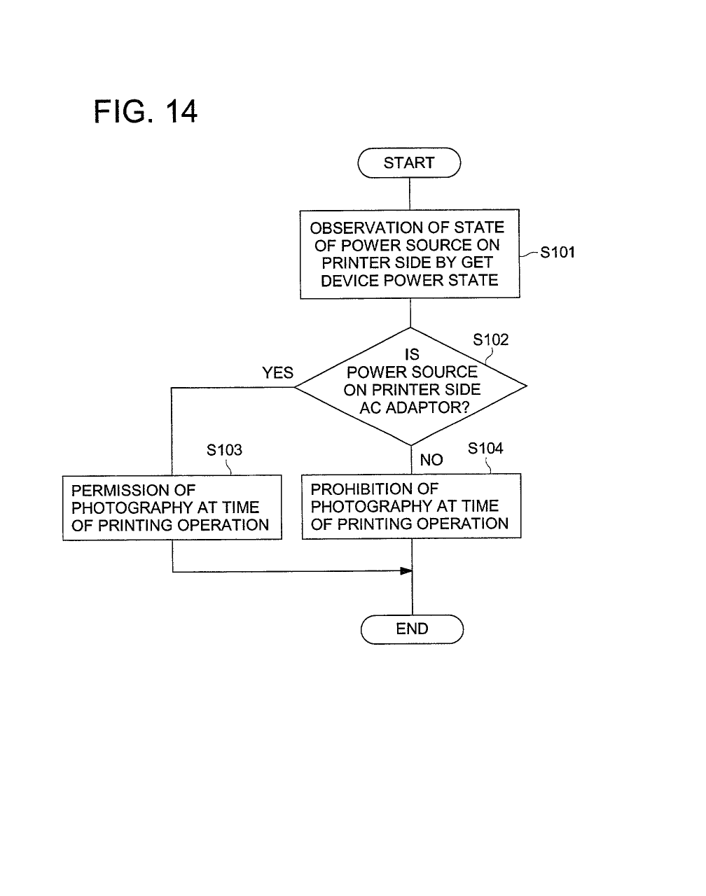

FIG. 14 is a flow chart showing such the control. In step S101 in FIG. 14, the camera control CPU 18 monitors the print section 50, and judges whether it receives the electric power supply from the AC adapter Adp (step S102). A basis of the judgment will be described later.

Herein, when it is judged that the print section 50 receives the electric power supply from the AC adapter Adp, the camera control CPU 18, in step 103, allows the photographing operation in parallel with the print operation. Accordingly, when the release button is operated during the printing, the photographing is usually conducted. By this parallel photographing operation, even during the printing, the photographing of the next object can be conducted, and the shutter chance in the printing time is not missed.

On the one hand, when it is judged that the print section 50 does not receive the electric power supply from the AC adapter Adp, because it is judged that the print section 50 receives the electric power supply from the battery Bt, the camera control CPU 18, in step S104, inhibits the photographing operation in parallel with the printing operation. Accordingly, when the release button is operated during the printing, the photographing is conducted after the print completion. By this time serial processing, it can be avoided that the maximum supply current of the battery is carelessly increased and the life of the battery is shortened, or the problem in the safety caused by flowing the current exceeding the regulated value can be avoided.

In this connection, it is not necessary that the inhibition of the release button does not continue after the completion of the all printing for each image, and for example, in the case of the printing by the ink ribbon, because the image is printed for each color component, the photographing may also be allowed properly timing the completion time of the printing of the present color component.

FIG. 18 is a flow chart showing the control to arbitrate the timing of the printing and the photographing. In FIG. 18, initially, under the supposition that releasing is not accepted during the printing, after the printing is completed for the present color component, the print section 50 conducts the heading for printing, for the next color ink ribbon (step S301).

In the succeeding step S302, when it is judged that release input is not inputted up to such the step, the print section 50 conducts printing for the next color ink ribbon. On the other hand, in step S302, when it is judged that release input is inputted, in step S304, the electronic camera section 10 starts the photographing preparing motion (photometry, focusing, and others), and conducts the photographing in step S305. After that, in step S306, the print section 50 conducts the printing for the next color ink ribbon. Hereinafter, the same control is repeated for each switching of color component.

According to the present embodiment, the camera control CPU 18 as the control means can judge that the receiving electric power is from the AC adapter Adp or from the battery Bt, and when it is judged that the electric power is received from the battery Bt, while the print section 50 as the image recording means is printing, because the photographing operation by the electronic camera section 10 is inhibited, the interference to each other, which is caused when the recording and photographing are simultaneously conducted according to the electric power from the battery Bt with the limited capacity, is suppressed, and both the image printing with higher image quality and the capturing of the clear image signal not including the noise can be obtained. In this connection, the inhibition of the photographing operation may also be conducted when the camera control CPU 18 judges that the photographing operation can not be conducted in parallel with the printing motion according to the information of the power consumption such as voltage drop of the battery Bt.

Further, because the camera control CPU 18 can judge whether the photographing operation can be conducted, according to the information of the power consumption such as the voltage, when the battery Bt is used as the power source, the camera control CPU 18 detects that the voltage level is lower than a predetermined value and when the photographing can not be further conducted, the camera control CPU 18 can also take a processing by which the photographing is inhibited, thereby, the possibility of inappropriate photographing can be suppressed.

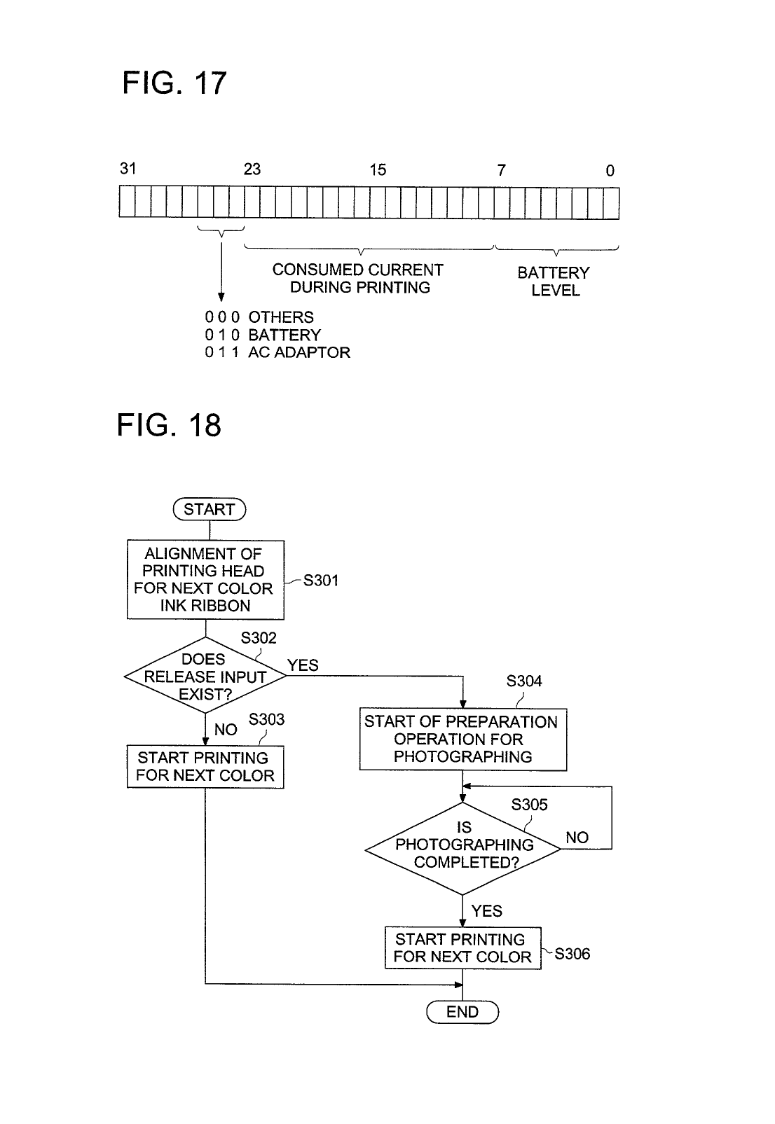

In this connection, the camera control CPU 18 can receive the information of the current consumption in the printing from the print section 50 as the information of the power consumption. More specifically, the current consumption level can be included in the Get Device Power State signal returned from the print section 50. FIG. 17 is a view showing an example of Get Device Power State. In the present embodiment, in 32 bits of the “Get Device Power State” signal, the lower 8 bits are assigned for the level of the battery Bt, and the succeeding 16 bits can be assigned for the current consumption at the printing (corresponds to 2 mA for 1 bit). In this connection, in 24 to 26 bits, for example, the information that the electric power is supplied from the AC adopter or the battery, can be transferred. According to such the information of the power consumption, the camera control CPU 18 can conduct the above described judgment.

In this connection, when the electronic camera section 10 and the print section respectively receive the electric power supply from the exclusive use batteries Bt as the different power sources, because the photographing and the printing are conducted by the electric power supplies from the separated power sources, and because, even when these operations are conducted in parallel with each other, the capability of the electric power source is not interfered on each other, in such the case, the photographing can be conducted during the printing operation.

As an example of variations of the present embodiment, it is considered that, when the camera control CPU 18 as the control means judges that the received electric power is from the battery Bt, the external interface 22 as the transfer means inhibits the photographing operation by the electronic camera section 10 when the image signal is transferred to the print section 50 or external equipment. Thereby, the interference onto the both caused by the case where the data transfer and the photographing are simultaneously conducted according to the electric power from the battery Bt with the limited capacity, is suppressed, and the print with higher image quality and the capturing of a clear image signal not including the noise can be obtained. In this connection, the inhibition of the photographic operation may also be conducted when the camera control CPU 18 judges that the photographing operation can not be conducted in parallel with the transferring according to the information of power consumption such as the voltage drop of the battery Bt. In the style of image signal output, other than the cable connection, the wireless connection such as IrDA, or the transfer through the storage medium such as the memory card, can be considered.

In this connection, in the case where the battery power is much consumed, and the image display section 20 displays the image, when the camera control CPU 18 decreases the brightness of the image display section 20 and, if circumstances require, image display is made not to be conducted, because the more power saving can be attained, thereby, the possibility that the print or transferring can be conducted, can be increased.

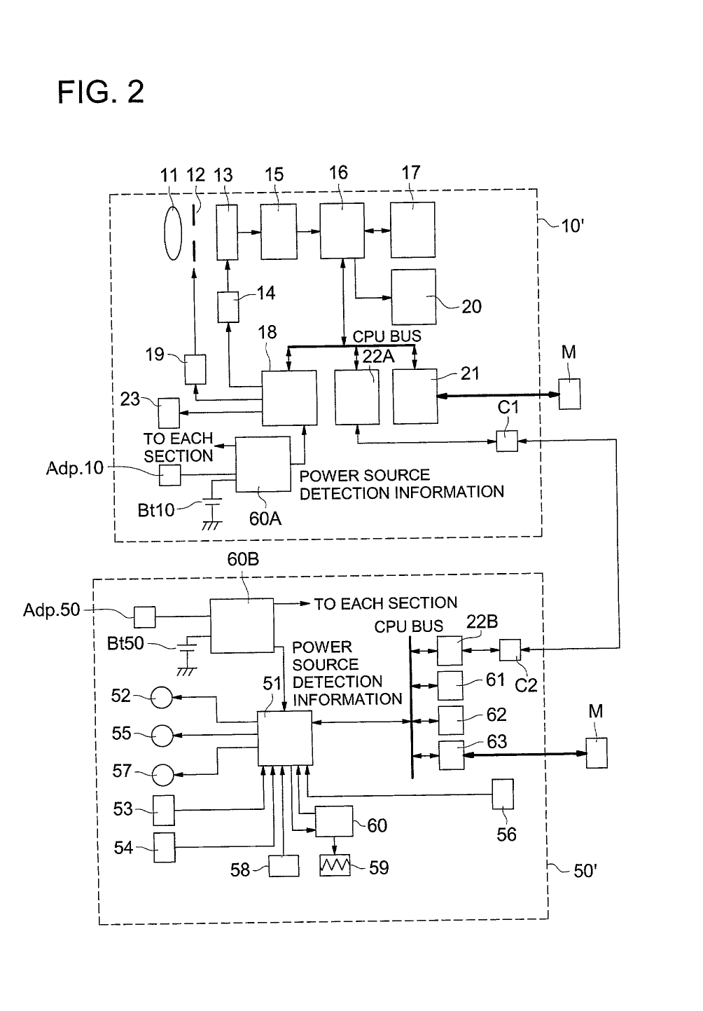

FIG. 2 is a block diagram of a camera unit 10′ and a printer unit 50′ showing the second embodiment. In the first embodiment, the electronic camera section 10 and the print section 50 are integrated with each other, however, in the present embodiment, the camera unit 10′ and the printer unit 50′ are separated from each other, and the imaging apparatus can be structured in the preferable combination. In this connection, the camera unit 10′ functions as the image display apparatus.

Because the camera unit 10′ and the electronic camera section 10 (FIG. 1) are basically the same structure, the detailed description is omitted, however, the power source section 60A which distributes and supplies the electric power from the adapter Adp 10 and the battery Bt 10, is exclusively used for the camera unit 10′.

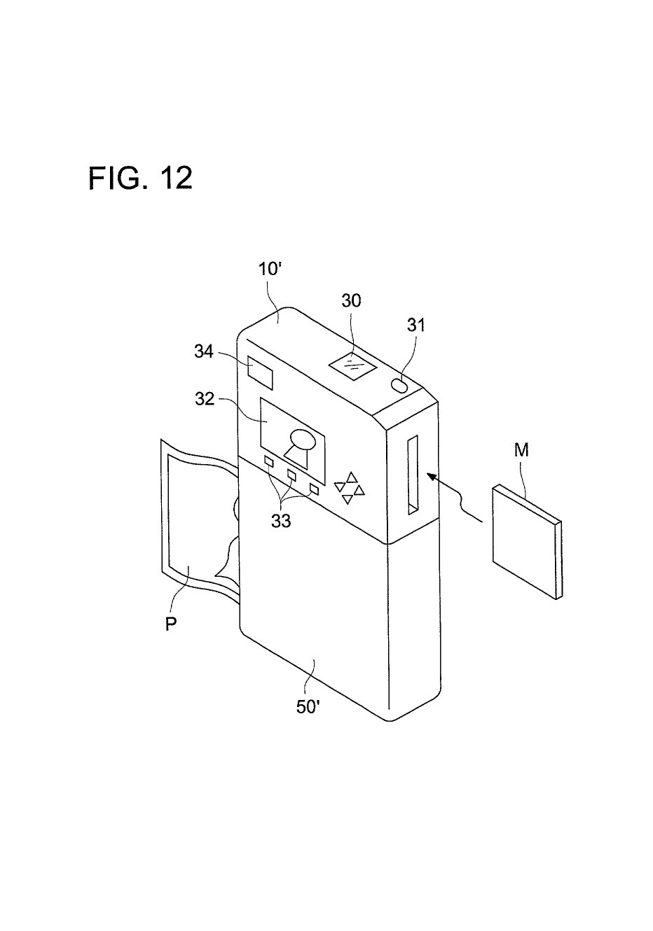

Further, because the printer unit 507 and the print section 50 (FIG. 1) are also basically the same structure, the detailed description is omitted, however, the power source section 60B which distributes and supplies the electric power from the adapter Adp 50 and the battery Bt 50, is exclusively used for the printer unit 50′, and further, the printer unit 50′ has the RAM 61 as an independent device, ROM 62 as an independent device, and the memory card control section 63 to make access to the memory card M and read the data stored in it. The camera unit 10′ and the printer unit 50′, which will be described later referring to FIG. 12, are made so that the external interface sections 22A and 22B, which behave as the output means or input means, can be directly connected to each other through the connectors C1 and C2, however, these may be connected by using, for example, the USB cable.

FIG. 12 is a perspective view showing the condition in which the camera unit 10′ and the printer unit 50′ are connected. On the upper surface of the camera unit 10′, a status LCD 30 to display the photographic mode or the number of exposed frames, and a release button 31 are provided, and further, on its back surface, an LCD 32 which is a display screen of the image display section 20, and its operation button 33 and a viewfinder 34 are provided, and further on its side surface, a receiving slot for the memory card M 35 is provided.

On the one hand, the printed image P is outputted from the side surface of the printer unit 50′.

In FIG. 12, the camera unit 10′ and the printer unit 50′ form an engagement portion, not shown, on the opposite surfaces, and when the camera unit 10′ and the printer unit 50′ are relatively moved, for example, in the width direction, the mechanical engagement and disengagement can be conducted.

When the engagement of the camera unit 10′ with the printer unit 50′ is completed, the connectors C1 and C2 shown in FIG. 2 are electrically connected, thereby, the camera control CPU 18 and the printer control CPU 51 can communicate with each other through the external interface sections 22A and 22B which are USB interfaces.

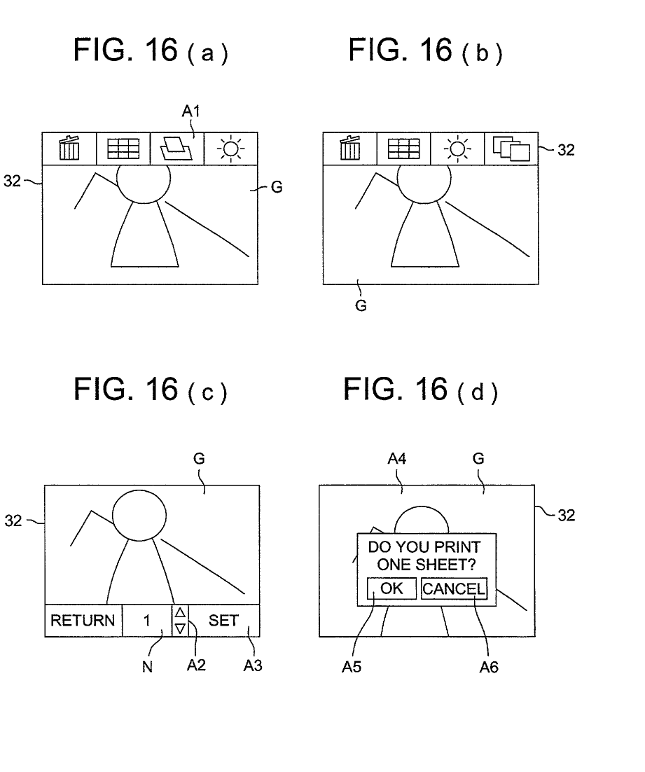

FIGS. 16(a), 16(b), 16(c), and 16(d) are views showing display examples of the display screens 32. When the camera unit 10′ and the printer unit 50′ can communicate to each other by connection, in the display screen 32 in FIG. 16(a), an icon Al showing the connection to the printer unit 50′ is displayed on the upper portion of the image G. On the other hand, when the camera unit 10′ and the printer unit 50′ cannot communicate to each other due to connection failure, as shown in FIG. 16(b), the icon A1 is not displayed on the upper portion of the image G.

In the condition shown in FIG. 16(a), when the operator presses the icon A1 on the display screen 32, the display screen 32 is switched to the display condition shown in FIG. 16(c). In such the display condition, the display N showing settable number of print sheets and an operation button A2 which can change the number of sheets, are displayed on the lower portion of the image G. In the case where the number of sheets is allowed, when the operator presses a setting button A3, the display screen 32 is switched to the display condition shown in FIG. 16(d). In such the display condition, the display A4 of the set number of print sheets, OK button AS, and cancel button A6 are displayed on the center of the image G, and when the operator looks at the display A4 and presses the OK button A5, the print is conducted by the printer unit 50′, and when the operator presses the cancel button A6, the display screen 32 is switched again to the display condition shown in FIG. 16(c), and the change of setting is allowed.

Also in the second embodiment, principally, the same operation as in the first embodiment is conducted, and when the image signal is transferred from the camera unit 10′ side to the printer unit 50′ side, because it is unknown that which printer unit 50′ is connected, there is a case that its printer characteristic can not be recognized. Accordingly, in the present embodiment, before the image signal is transferred, the information relating to the printer characteristic is read from the camera unit 10′ to the printer unit 50′, and by using it, the image signal is appropriately processed.

In the present embodiment, when these units are connected with each other through the USB interface, initially, the CPU structured in the host side equipment communicates with the CPU assembled in the connected equipment, and recognize the kind or characteristics of the connected equipment and selects the setting appropriate for the function of the host side from the characteristics of the connected equipment, and conducts the data transferring. Particularly, in the present embodiment, the camera control CPU 18 has the host function of the USB, and the print section 50′ is structured as the connected equipment.

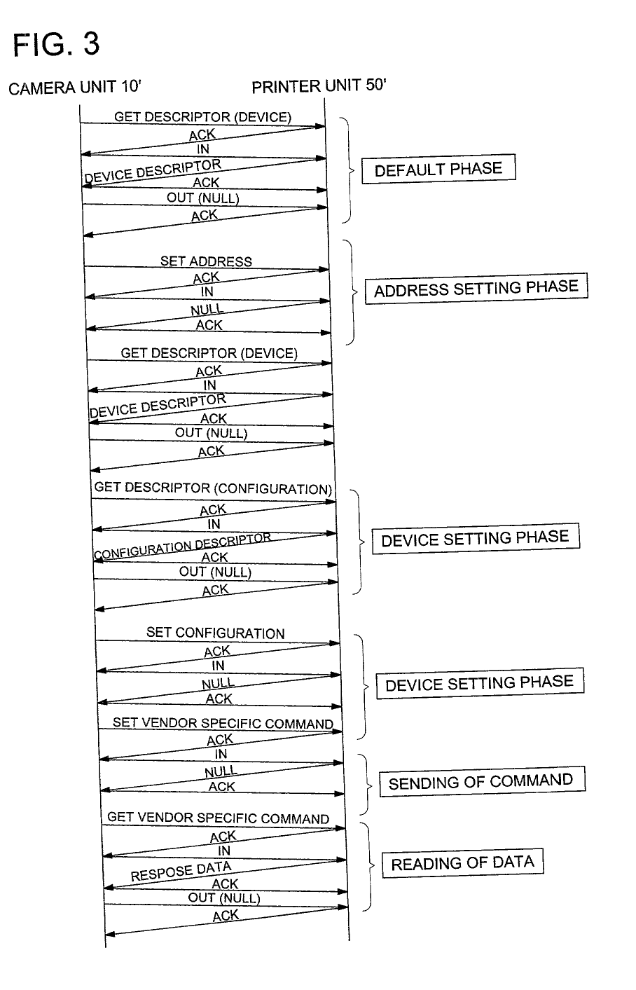

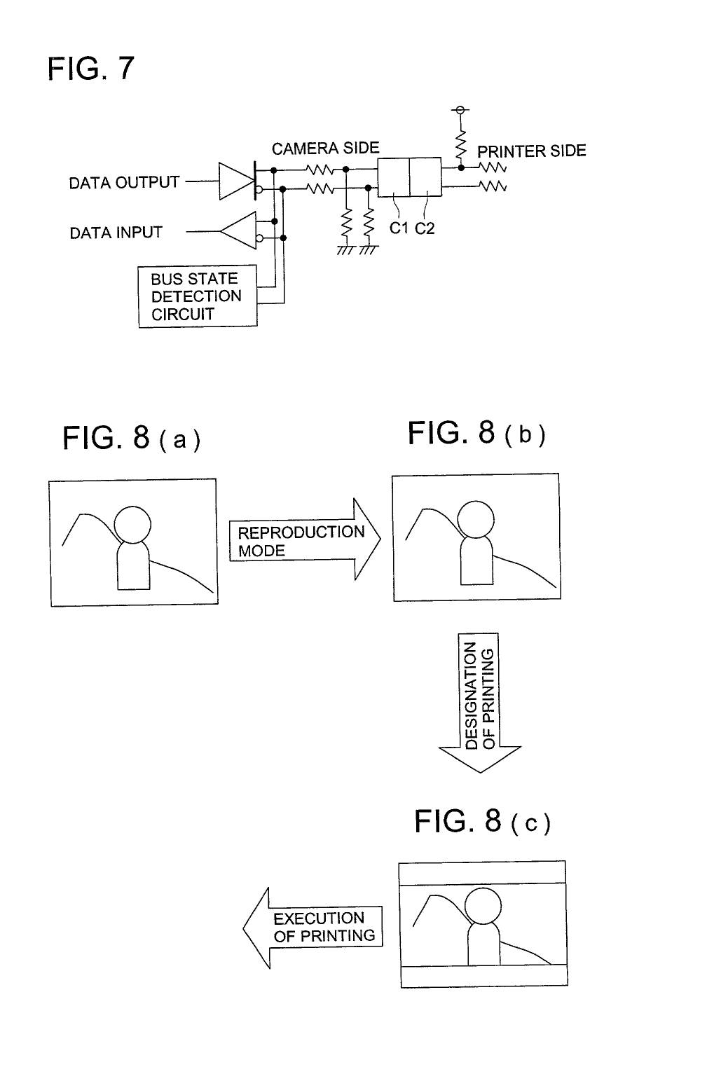

FIG. 3 is a ladder chart showing the transferring and receiving of the signal between the camera unit 10′ and the printer unit 50′ according to the second embodiment. FIG. 7 is a block diagram showing the structure of the external interface section. Initially, when the camera unit 10′ is connected to the printer unit 50′, in the external interface section 22A, when it is detected that one of the USB data signal line is pulled up to 3.3 V according to the power source supplied on the printer unit 50′ side, it is detected that the printer unit 50′ is connected, further, also on the printer side, it is detected that the interface power source is supplied, and its connection is detected. When the camera control CPU as the host side detects their connection, and the synchronous packet signal called “Start Of Frame” (hereinafter, SOF) showing the start of the USB frame packet is supplied. By this synchronous packet signal, the communication between the camera unit 10′ and the printer unit 50′ can be conducted.

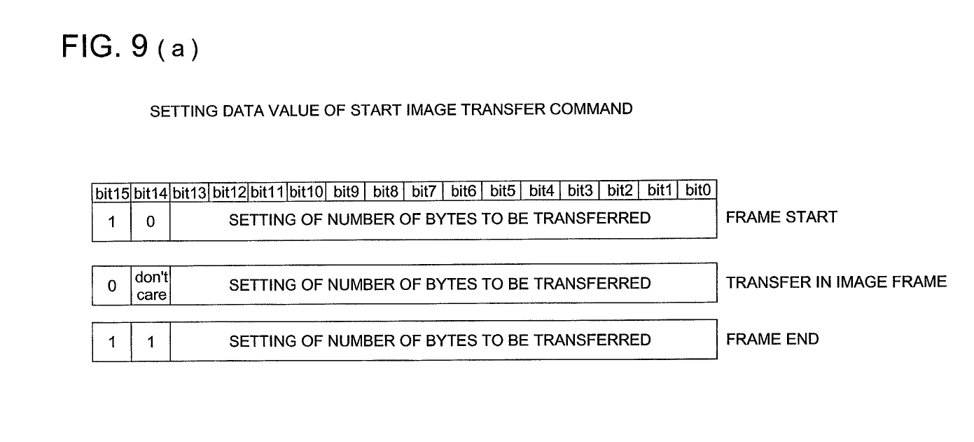

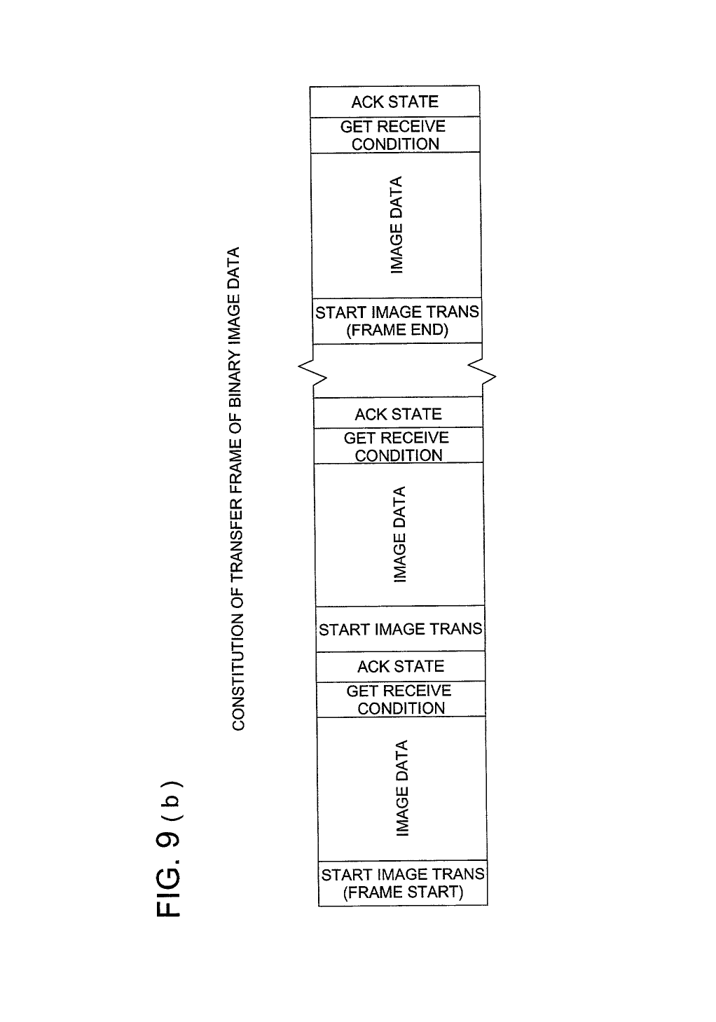

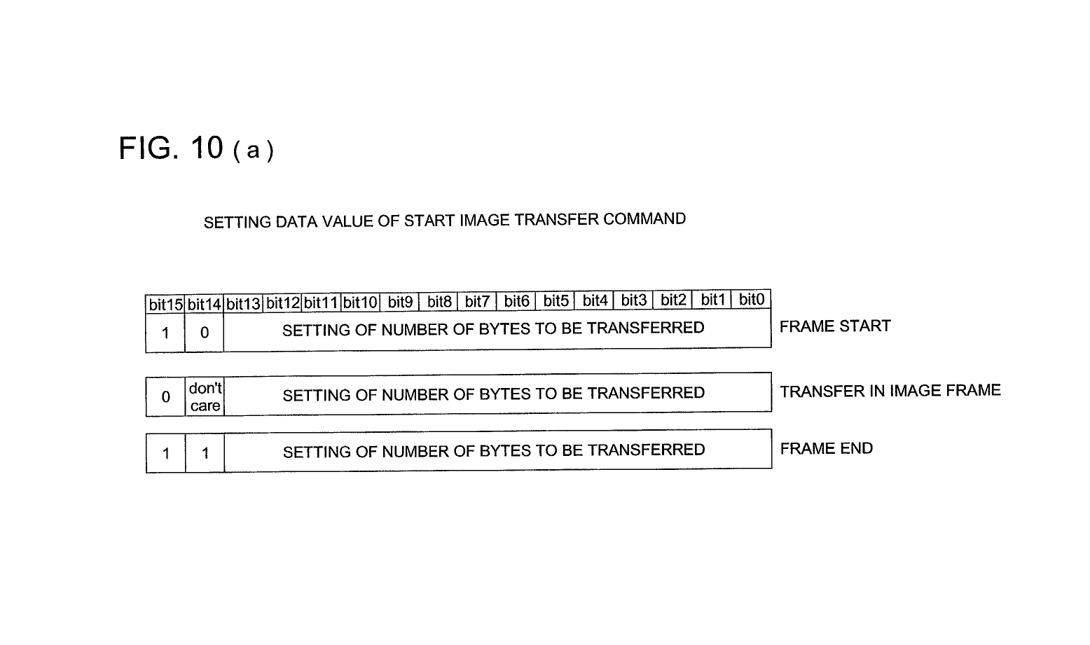

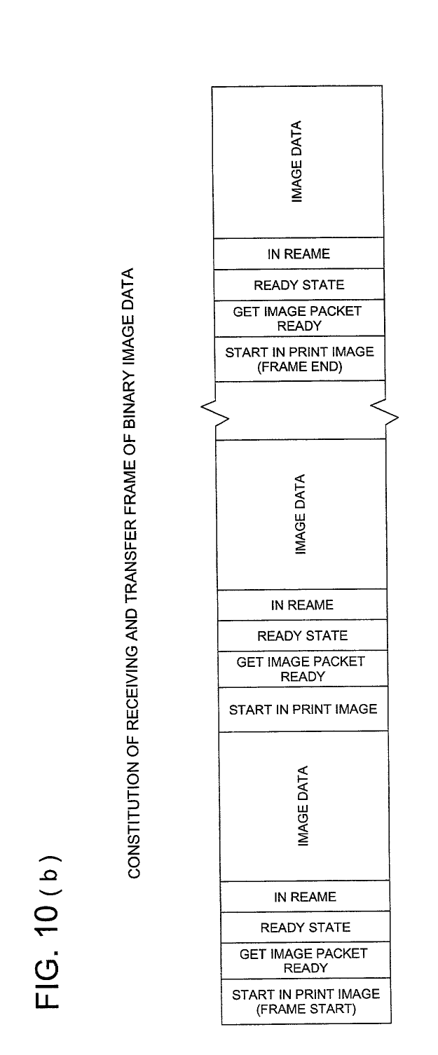

As shown in FIG. 3, after a predetermined time has passed, the camera control CPU 18 as the host side, requires “Device Descriptor” to the printer control CPU 51 at the default address of USB through the external interfaces 22A and 22B, and the printer control CPU 51 makes response of “Device Descriptor” that specifies printer unit 50′, to the camera control CPU 18 reversely tracing through the above route. When the camera control CPU 18 receives “Device Descriptor”, it is detected that the connected equipment is the printer unit 50′, and selects the control method appropriated for the printer unit 50′, and by using a new USB address other than the USB default address, makes response of “Configuration Descriptor” to the printer control CPU 51. When the camera control CPU 18 receives “Configuration Descriptor”, the setting condition of the interface of the USB of the printer control CPU 51 can be known, and a predetermined Configuration exclusively used for the interface of the camera unit 10′ and the printer unit 50′ is set to the printer control CPU 51. Specific data transfer is described in FIGS. 9(a) to 12(b).

According to the above description, the camera unit 10′ and the printer unit 50′ can respectively know the connected equipment, and can use the image processing content corresponding to the connected equipment, data format structure, communication instructions specific to the equipment itself, or image size. More specifically, corresponding to the printer characteristic read from the printer unit 50′, the image signal according to the image photographed by the camera unit 10′ is processed, or corresponding to the image size which can be outputted by the printer unit 50′, the interpolation processing for the change of the image size can be conducted on the image signal outputted from the camera unit 10′.

Herein, an example using the USB is shown, however, when it is an interface method by which the negotiation at the beginning of the communication between the equipments can be conducted, it is clear that the recognition of both equipments is possible, and the present invention is not limited by the USB itself. For example, it can be easily understood by the skilled persons that, when a serial communication represented by RS-232C or RS-422, and an interface such as IEEE1394 are used, the same effect can be obtained.

In this connection, in the relationship between the connected camera unit 10′ and printer unit 50′, there is a case where it is not preferable to fix the CPU to conduct the image processing. That is, it is because, in the CPUs of the camera unit 10′ and printer unit 50′, the image processing with much more functions can be more quickly conducted when the image processing is conducted by the CPU having the higher processing capability. Accordingly, in the present embodiment, when the camera unit 10′ and the printer unit 50′ are connected, this system is structured in such a manner that it can be judged that by which CPU the image processing is conducted.

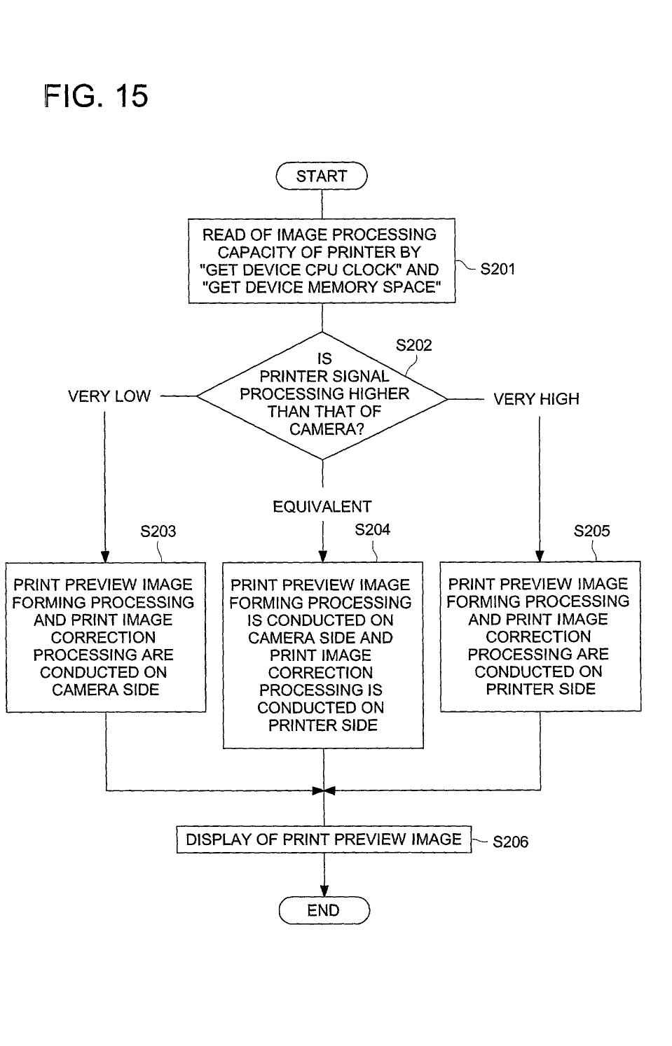

FIG. 15 is a flow chart to conduct such the judgment. Initially, in step S201, when the camera unit 10′ and the printer unit 50′ are connected, the camera control CPU 18 reads out the image processing capability of the printer control CPU 51, and compares it with its own capability (step S202). Herein, when the camera control CPU 18 judges that the image processing capability of the printer control CPU 51 is very much lower than its own image processing capability, the camera control CPU 18 conducts the print image correction processing and print pre-view image formation processing by itself (step S203), and in step S206, displays the formed print pre-view image.

On the one hand, in step S202, when the camera control CPU 18 judges that the image processing capability of the printer control CPU 51 is almost the same as its own image processing capability, the camera control CPU 18 causes the printer control CPU 51 to conduct the print image correction processing, and by using the processed data, the camera control CPU 18 conducts the print pre-view image formation processing (step S204), and in step S206, displays the formed print pre-view image.

Further, in step S202, when the camera control CPU 18 judges that the image processing capability of the printer control CPU 51 is very much higher than its own image processing capability, the camera control CPU 18 causes the printer control CPU 51 to conduct the print image correction processing and the print pre-view image formation processing (step S205), and in step S206, the camera control CPU 18 displays the formed print pre-view image.

As described above, according to the present embodiment, this system is structured in such a manner that, corresponding to the comparison of the CPU capability, the image signal obtained by the camera unit 10′ is transferred to the printer unit 50′ side, and the image processing can also be conducted by the printer control CPU 51 as the image processing means and the output means. In this connection, the processed image signal may be returned to the camera unit 10′, or may be outputted to the other electronic camera.

Further, in the case where the image signal after the processing is inputted to the camera unit 10′ side, when the image display section 20 conducts, for example, the pre-print pre-view image display according to the image signal, because the image after the processing can be confirmed, it is preferable.

Further, in the printer control CPU 51 of the printer unit 50′, it is preferable that the template processing can be conducted on the inputted image signal. “The template processing” means that the image processing is conducted on the photographed image so that it is formed into a form of the New Year's card or the calendar, or the image is processed so that it is image composed as if the object is settled in a photo-frame, as if the object is photographed together with cartoon characters, or the processing by which the beautiful landscape and the object image are composed, however, it is not limited to those.

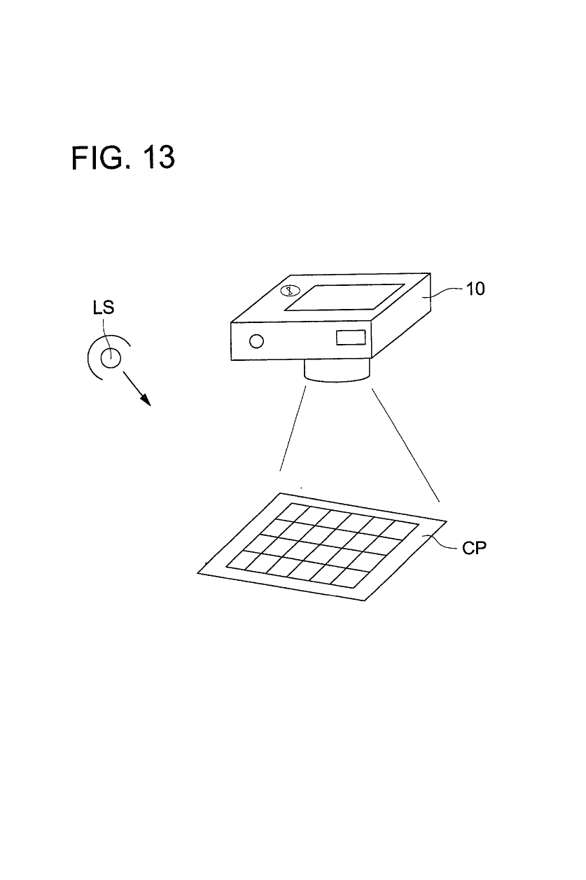

FIG. 13 is a view for explaining the output characteristic correction method according to the third embodiment. Initially, a predetermined color patch CP on which a plurality of rectangles with the different gradations are printed, is photographed by the electronic camera section 10, and is printed by the print section 50 as an image. Further, the original color patch CP and the printed color patch (not shown) are compared with each other, and the output characteristic of the print section 50 is corrected from the lightness and the chromaticness. According to such the output characteristic correction method, there is an advantage that, even when the characteristic such as the color temperature of the light source LS or the image pick-up characteristic of the electronic camera section 10 is unknown, by correcting only the output characteristic of the print section 50, the original image can be reproduced. In this connection, instead of the correction of the output characteristic of the print section 50, or in addition to that, the image pick-up characteristic of the electronic camera section 10 may also be corrected.

As more specific correction modes, it is considered that the printed color patch is photographed by the same electronic camera section 10 under the same light source LS, and the image signal is obtained, and it is compared with the image signal obtained by previously photographing the original color patch CP, and the output characteristic of the print section 50 is corrected so that each of data values approaches to each other, however, the correction modes are not limited to this, but, may also be, for example, trial and error.

As described above, referring to embodiments, the present invention is described, however, the present invention is not to be construed being limited to the above embodiments, but, of course, the modification and the improvement may also be appropriately conducted.

According to the present invention, the imaging apparatus, image recording system and image recording apparatus, by which desired image print can be obtained without using the personal computer, can be provided.

What is claimed is:

1. An imaging apparatus comprising:
(a) an image sensor for inputting an object image and for obtaining image signals;
(b) an image processing means for image-processing the obtained image signals according to printer characteristic information; and
(c) a display means for displaying an image on the basis of the image signals processed by the image processing means.

2. An imaging apparatus comprising:
(a) an image sensor for inputting an object image and for obtaining image signals;
(b) a first image processing means for image-processing the obtained image signals;
(c) a second image processing means for image-processing the obtained image signals according to printer characteristic information;
(d) a selection means for selecting either the first image processing means or the second image processing means; and
(e) a display means for displaying an image according to the image signals processed by either the first image processing means or the second image processing means.

3. The imaging apparatus of claim 2 further comprising:
a memory means for storing the obtained image signals, wherein the first and second image processing means image-process the respective image signals stored in the memory means.

4. The imaging apparatus of claim 1, wherein the printer characteristic information is contained in the imaging apparatus.

5. The imaging apparatus of claim 2, wherein the printer characteristic information is contained in the imaging apparatus.

6. The imaging apparatus of claim 1 further comprising an input means for inputting the printer characteristic information from an outside of the imaging apparatus.

7. The imaging apparatus of claim 2 further comprising an input means for inputting the printer characteristic information from an outside of the imaging apparatus.

8. The imaging apparatus of claim 6, wherein the printer characteristic information is inputted from a printer when the printer is connected with the imaging apparatus.

9. The imaging apparatus of claim 7, wherein the printer characteristic information is inputted from a printer when the printer is connected with the imaging apparatus.

10. The imaging apparatus of claim 2, wherein the selection means selects when the imaging apparatus is connected with a printer.

11. The imaging apparatus of claim 10, wherein the selection means selects the second image processing means when the imaging apparatus is connected with the printer.

12. An image recording system comprising:
(a) an imaging apparatus having
(1) an image sensor for inputting an object image and for obtaining image signals, and
(2) a first output means for outputting the image signals to an outside; and
(b) an image recording apparatus having
(1) an input means for inputting the image signals output from the first output means,
(2) an image processing means for image-processing the image signals according to a recording characteristic,
(3) an image recording means for printing on the basis of the image signals processed by the image processing means, and
(4) a second output means for outputting the image signals processed by the image processing means to an outside.

13. The image recording system of claim 12, wherein the image recording apparatus conducts processing on the basis of instructions from the imaging apparatus when the imaging apparatus is connected with the image recording apparatus.

14. The image recording system of claim 12, wherein the image signals processed by the image recording apparatus is inputted to the imaging apparatus, and an image display is conducted on the basis of the image signals.

15. The image recording system of claim 12, wherein a template processing to input image signals is conducted in the image recording apparatus.

16. An image recording system comprising:
(a) an image recording apparatus having
(1) a first input means for inputting image signals,
(2) an image processing means for image-processing the image signals according to a printer characteristic,
(3) an image recording means for printing according the image signals processed by the image processing means, and
(4) an output means for outputting the image signals processed by the image processing means to an outside; and
(b) an image display apparatus having
(1) a second input means for inputting the image signals output from the output means, and
(2) a display means for displaying an image according to the image signals input from the second input means.

17. The image recording system of claim 16, wherein the image display apparatus further comprises an image sensor for inputting an object image and for obtaining image signals thereof.

18. The image recording system of claim 16, wherein the image recording apparatus conducts recording operation according to instructions from the image display apparatus when the image display apparatus is connected with the image recording apparatus.

19. The image recording system of claim 16, wherein a template processing to input image signals is conducted in the image recording apparatus.

20. An image recording apparatus comprising:
(a) an input means for inputting image signals;
(b) an image processing means for image-processing the image signals input from the image input means according to a print characteristic;
(c) an image recording means for printing according to the image signals processed by the image processing means; and
(d) an output means for outputting the image signals processed by the image processing means to an outside.

21. The image recording apparatus of claim 20, wherein a template processing is conducted to input image signals in the image recording means.

22. An imaging apparatus comprising:
(a) an image sensor for inputting an object image and for obtaining image signals;
(b) an image recording means for printing according to the image signals obtained by the image sensor;
(c) a power source for supplying electric power to the image sensor and the image recording means; and
(d) a controller for prohibiting a photographing operation by the image sensor during a recording operation by the image recording means.

23. An imaging apparatus comprising:
(a) an image sensor for inputting an object image and for obtaining image signals;
(b) an image recording means for printing according to the image signals obtained by the image sensor;
(c) a power source for supplying electric power to the image sensor and the image recording means; and
(d) a judgment means for judging whether or not a photographic operation by the image sensor during a recording operation by the recording means is conducted according to information of electric power consumption on the image recording means and the image sensor.

24. An imaging apparatus comprising:
(a) an image sensor for inputting an object image and for obtaining image signals;
(b) an image recording means for printing according to the image signals obtained by the image sensor;
(c) a power source for supplying an electric power to the image sensor and the image recording means; and
(d) a controller for making the image recording means to suspend a recording operation when a photographing operation by the image sensor is instructed during the recording operation by the image recording means, for making the image sensor to photographing, and then for making the image recording means to restart the recording operation after the photographing operation of the image sensor is finished.

25. An imaging apparatus comprising:
(a) an image sensor for inputting an object image and for obtaining image signals;
(b) a power source for supplying electric power to the image sensor;
(c) an image recording means which receives a power supply from a power source different from the power source for the image sensor, for printing according to the image signals obtained by the image sensor; and
(d) a controller for enabling a photographing operation by the image sensor even during a recording operation by the image recording means.

26. An imaging apparatus comprising:
(a) an image sensor for inputting an object image and for obtaining image signals;
(b) a transfer means for transferring signals to an outside according to the image signals obtained by the image sensor;
(c) a power source for supplying electric power to the image sensor and the transfer means; and
(d) a controller for prohibiting a photographing operation by the image sensor during a transfer operation by the transfer means.

27. An imaging apparatus comprising:
(a) an image sensor for inputting an object image and for obtaining image signals;
(b) a transfer means for transferring signals to an outside according to the image signals obtained by the image sensor;
(c) a power source for supplying electric power to the image sensor and the transfer means; and
(d) a judgment means for judging whether or not a photographic operation by the image sensor during a transferring operation of the transfer means is conducted according to information of electric power consumption on the transfer means and the image sensor.

28. An imaging apparatus comprising:
(a) an image sensor for inputting an object image and for obtaining image signals;
(b) a transfer means for transferring signals to an outside according to the image signals obtained by the image sensor;
(c) a display means for displaying an image according to the image signals obtained by the image sensor;
(d) a power source for supplying electric power to the image sensor and the transfer means; and
(e) a controller for lowering a luminance for an image display of the display means during a transferring operation of the transfer means.

29. The imaging apparatus of claim 28, wherein the controller makes the display means not to conduct the image display.

30. An output characteristic correction method, comprising the steps of:
(a) photographing a predetermined image and obtaining image signals therefrom;
(b) outputting an image according to the image signals obtained by a predetermined output characteristic and an image sensor; and
(c) correcting the predetermined output characteristic according to the output image and the predetermined image.

31. An output characteristic correction method, comprising the steps of:
(a) photographing a predetermined image and obtaining a first image signal therefrom;
(b) outputting an image according to the first image signal obtained by a predetermined output characteristic and an image sensor;
(c) photographing the output image and obtaining a second image signal therefrom; and
(d) correcting the predetermined output characteristic according to the first image signal and the second image signal.
